(19) United States
(12) Patent Application Publication
(10) Pub. No.: US 2015/0032569 A1
(43) Pub. Date: Jan. 29, 2015

(54) SERVICE ACCESS USING IDENTIFIERS

(71) Applicant: Samuli Strömberg, Tampere (FI)

(72) Inventor: Samuli Strömberg, Tampere (FI)

(73) Assignee: SMARTRAC IP B.V., Amsterdam (NL)

(21) Appl. No.: 14/365,156

(22) PCT Filed: Dec. 16, 2011
(86) PCT No.: PCT/FI2011/051124

§ 371 Date: Sep. 22, 2014

(51) Int. Cl. G06Q 30/06

(52) U.S. Cl. CPC G06Q 30/0609
USPC 705/26.35

(57) ABSTRACT

A method and system for providing access to a service. An identification for identifying a tag and information for accessing a service are formed. The service can utilize the identification for accessing the service. A second identification for identifying a person or a group of people is formed for the service to use, and the two identifications are associated with each other for easy access to the service.

### FIELD

The aspects of the present disclosure relate to accessing a service using an identifier, and to tags, systems, methods and computer program products for enabling the same, especially with a product-related identifier.

### BACKGROUND

The emergence of internet services in recent years has made it possible to e.g. share product information easily to potential customers. Some companies have utilized this opportunity even to build web portals for customers for e.g. providing additional services related to a product such as user manuals, software downloads and such. These web portals may provide a way for the customer to request service and communicate with the manufacturer or seller of the product.

Typically, a product support portal like the one described above requires the identification of the product for which support is sought. This may require a series of operations by the user, e.g. to select a product type, a product range, an individual product and possibly a specific model of the product. Such operations may be clumsy and time-consuming for the user, and may degrade the experience of using a product. Similar issues arise with other services than internet-based services, too, making it difficult for users to access or use these services.

There is, therefore, a need for a solutions that provide an easier access to a service, especially service related to a product.

### SUMMARY

Now there has been invented an improved method and technical equipment implementing the method, by which the above problems are alleviated. Various aspects of the present disclosure include methods, reader apparatuses, a systems, a remote-access devices and computer readable media comprising computer programs stored therein for carrying out the methods and operating the devices, which aspects are characterized by what is stated in the independent claims. Various embodiments of the present disclosure are disclosed in the dependent claims.

The present disclosure relates to providing access to a service. An identification for identifying a tag and information for accessing a service are formed. The service can utilize the identification for accessing the service. A second identification for identifying a person or a group of people is formed for the service to use, and the two identifications are associated with each other for easy access to the service.

For example, an RFID or NFC tag may comprise a memory for storing an identifier of the tag and/or a product to which the tag is associated or attached. In addition, the tag may comprise a memory for storing an identifier of a person, such as a name, number identifier, loyal customer card number or credit card number. When the product is purchased at the point of sales, e.g. at a cash register, or at another relevant point where the person identity is available, the person identity information may be stored on the tag or the information may otherwise be associated with the tag. The person may then access a product-related service by using the information of the tag and the person identification. This may make it easier to access the service, because the person may avoid inserting product information and/or person identification to the service manually. The service may then provide information based on the product and person identification, e.g. offer related products and/or data, or request product feedback from the user. If the person identification is partial in the sense that it allows anonymity to be maintained, feedback information may be associated to groups of people without ever requesting any personal information to be entered by the user.

According to a first aspect there is provided a method for providing access to a service, comprising forming a first identification for identifying a tag or a tagged object, and forming information for accessing a service, said service being adapted to utilize said first identification or first data derived from said first identification, forming a second identification for identifying a person or a group of people, wherein said service is adapted to utilize said second identification or second data derived from said second identification, and associating said second identification with said first identification for providing access to said service.

According to an embodiment, the second identification is formed at a point of sale by using customer information in response to said customer making a purchase of a product to which said tag is attached. According to an embodiment, said associating comprises storing said second identification into said tag. According to an embodiment, the method comprises storing said second identification on a computer in a network, and associating said first identification with said second identification on said computer. According to an embodiment, the method comprises storing said information for accessing said service into said tag. According to an embodiment, said first identification comprises at least one from the group of a tag identifier, a product identifier, an article number, a serial number, a type identifier, a name of a product, a name of a company having manufactured the product, a link to a product-specific service and a link to a product-type-specific service. According to an embodiment, said second identification comprises a sale identifier such as a sale receipt number, a customer name, a customer payment card number, a loyal customer identifier, a sales clerk identifier, a store identifier, a location identifier or a time.

According to a second aspect, there is provided a method for providing a service, comprising receiving a first identification for identifying a tag or a tagged object, and receiving a service request comprising information for accessing a service such as an address to said service, said service being adapted to utilize said first identification or first data derived from said first identification, receiving a second identification for identifying a person or a group of people, wherein said service being adapted to utilize said second identification or second data derived from said second identification, said second identification being associated with said first identification, and providing a service based on said first identification and said second identification.

According to an embodiment, said first identification and said second identification are received from a tag memory. According to an embodiment, said first identification is received from a tag memory and the method comprises receiving said second identification from a network server based on said first identification. According to an embodiment, the method comprises using said first identification or said second identification as a basis for randomly generating service. According to an embodiment, said first identification comprises at least one from the group of a tag identifier, a product identifier, an article number, a serial number, a type identifier, a name of a product, a name of a company having manufactured the product, a link to a product-specific service and a link to a product-type-specific service. According to an embodiment, said second identification comprises a sale identifier such as a sale receipt number, a customer name, a customer payment card number, a loyal customer identifier, a sales clerk identifier, a store identifier, a location identifier or a time.

According to a third aspect there is provided a method for accessing a service, comprising forming a first identification for identifying a radio frequency identification tag or a tagged object, forming information, such as a hyperlink, for accessing a service based on said first identification or first data derived from said first identification, forming a second identification for identifying a person or a group of people, wherein said service is adapted to utilize said second identification or second data derived from said second identification, associating said second identification with said first identification, retrieving said first and second identification for accessing said service, and accessing said service by using said first and second identification.

According to a fourth aspect there is provided a computer program product comprising computer program code embodied on a non-transitory computer-readable medium, the computer program code being configured to, when run on at least one processor, cause a computer system to carry out the method according to any of the previous aspects.

According to a fifth aspect there is provided a tag such as an RFID transponder, comprising a first identification for identifying said tag and for accessing a service, and a second identification for identifying a person or a group of people and for accessing a service, said service being adapted to utilize said first identification or first data derived from said first identification and said second identification or second data derived from said second identification.

According to an embodiment, the tag comprises information for accessing said service in said tag such as an http address or a server IP address. According to an embodiment, said second identification comprises a sale identifier such as a sale receipt number, a customer name, a customer payment card number, a loyal customer identifier, a sales clerk identifier, a store identifier, a location identifier or a time.

According to a sixth aspect there is provided a system for providing access to a service, said system comprising memory and at least one processor, the system further comprising computer program code in said memory, said computer program code arranged to, when executed on said at least one processor, cause the system to form a first identification for identifying a tag or a tagged object, and form information for accessing a service, said service being adapted to utilize said first identification or first data derived from said first identification, form a second identification for identifying a person or a group of people, wherein said service is adapted to utilize said second identification or second data derived from said second identification, and associate said second identification with said first identification for accessing said service.

According to an embodiment, the system further comprises computer program code arranged to cause the system to determine customer information in response to said customer making a purchase of a product to which said tag is attached; and form said second identification by using said customer information. According to an embodiment, the system further comprises computer program code arranged to cause the system to store said second identification in said tag. According to an embodiment, the system further comprises computer program code arranged to cause the system to store said second identification on a computer in a network, and cause said first identification to be associated to said second identification on said computer.

According to a seventh aspect there is provided a system for providing a service, said system comprising memory and at least one processor, the system further comprising computer program code in said memory, said computer program code arranged to, when executed on said at least one processor, cause the system to receive a first identification for identifying a tag or a tagged object, and receive a service request comprising information for accessing a service such as an address to said service, said service being adapted to utilize said first identification or first data derived from said first identification, receive a second identification for identifying a person or a group of people, wherein said service being adapted to utilize said second identification or second data derived from said second identification, said second identification being associated with said first identification, and provide a service based on said first identification and said second identification.

According to an embodiment, the system further comprises computer program code arranged to cause the system to receive said second identification from a network server based on said first identification. According to an embodiment, said second identification comprises a sale identifier such as a sale receipt number, a customer name, a customer payment card number, a loyal customer identifier, a sales clerk identifier, a store identifier, a location identifier or a time.

### DESCRIPTION OF THE DRAWINGS

In the following, various embodiments of the present disclosure will be described in more detail with reference to the appended drawings, in which

FIGS. 1a and 1b show block diagrams of an RFID or NFC tag and a reader device according to the present disclosure;

FIGS. 2a and 2b show tags with identification data stored in the tag memory according to the present disclosure;

FIGS. 3a and 3b show a system and a method for manufacturing and modifying tags for accessing a service according to the present disclosure;

FIG. 4 shows a system for providing a service according to the present disclosure; and

FIGS. 5a and 5b show a flow chart for accessing a service and for providing a service according to the present disclosure.

### DESCRIPTION OF EXAMPLE EMBODIMENTS

In the following, several embodiments of the present disclosure will be described in the context of radio frequency identification (RFID) tags or near-field communication (NFC) devices. It is to be noted, however, that the present disclosure is not limited to RFID and NFC tags and systems only. In fact, the different embodiments have applications widely in any environment where capabilities of providing a service more easily are needed.

Over time, the needs of having various kinds of information available on a product outgrew the capabilities of a simple bar code. To this end, new technologies were developed, such as two-dimensional bar codes. Of such technologies, radio frequency identification (RFID) has rather quickly become the technology of choice for identifying and tracking items. RFID technology has a vast number of applications making use of the ability to read an RFID tag from a distance even without a line-of-sight connection between the reader and the tag. RFID is quickly replacing or at least augmenting the bar code technology in many places. A technology based on the RFID technology is near-field communication (NFC) technology, where a reader device can act both as a reader and as a tag.

The basic information that an RFID tag carried has traditionally been electronic product code (EPC) information and/or tag identification information. RFID tags with more capabilities may have the ability to store more information in the tag memory, and even carry out some processing of data.

A radio frequency identification tag (RFID tag) of NFC tag typically comprises a chip and an antenna connected to the chip, attached to or protected inside a plastic layer. The RFID or NFC chip contains analog and/or digital processing circuitry, e.g. a state machine and/or a processor and memory for storing information, as well as circuitry for receiving radio frequency (RF) energy and modulating the RF wave. The chip is connected to the antenna, whose shape and size depend on the frequency at which the tag operates and the application for which the tag is used. The chip and the antenna are often laid inside a thin plastic laminate or container for protection. The tag as a whole is typically flexible to a certain degree, especially the passive tags that do not contain a power supply.

Passive tags use the energy from the radio-frequency electromagnetic field of the read-out signal to power the operations that the tag carries out. Passive tags operate essentially while they are in the reader field, and are essentially inactive at other times. As described above, the tag causes a response to the reader signal to be available in the electromagnetic field, and thus acts as a transponder. In other words, a device where there is an antenna connected to a chip so that it can respond to a read-out signal may be understood to be a transponder. A tag comprising these elements may also be understood to be a transponder. The farther the reader device and the weaker the read-out signal, the less energy is available for the tag to use. This in turn means that the tag may not be able to perform very complex operations that would require a lot of power, since such tags could only be read from a short distance away. In other words, the read-out distance of a tag is to a large extent determined by the power consumption requirements of the tag. Naturally, the attenuation and power distribution of the electromagnetic signal emitted by the tag is another concern. To tackle this issue, some passive tags have a battery that may be used to power the processing circuitry and thereby allow longer operating range for the tag. Such tags that use an internal power source to energize the response signal may be called semi-passive tags.

A transponder may be understood to be any remotely accessible identification device that responds to an identification query by sending back an identification signal e.g. by means of back-scattering. For example, smart tags operating over radiofrequency connection such as a RFID tag, NFC tag or RF-EAS tag (radiofrequency electronic article surveillance), tags for theft protection, tickets for travel or access to events, smart cards, stickers or labels etc. may be transponders in the context of the present disclosure.

NFC tags may operate as follows. The NFC tags may be designed so that their effective read-out distance is very short, for example of the order of a few centimeters or even a few millimeters. In practice, the user of a NFC tag touches the tag physically with his readout device, and the tag may have a visible aiming pattern to assist the user. Alternatively, the readout device may be fixed, e.g. embedded in a cashier's station, whereby the product is moved close to the readout device in order to read the data on the tag. It has also been noticed in the present disclosure that the writing data onto the tag may prove useful.

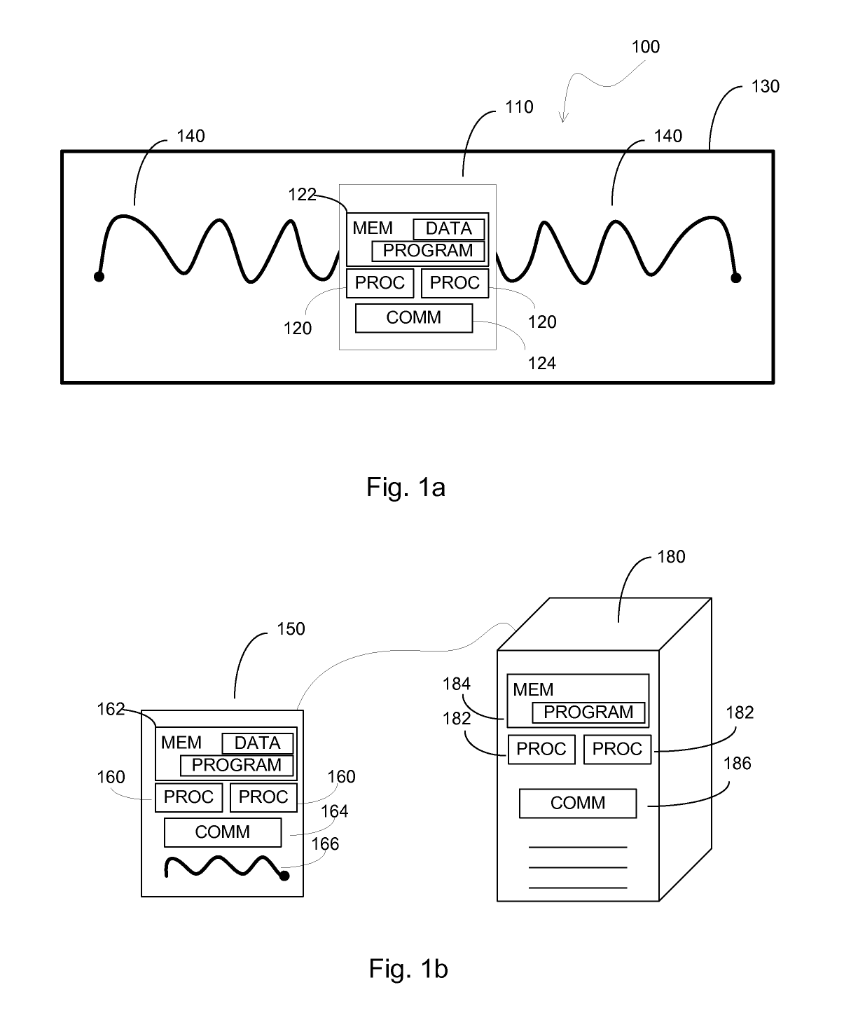

FIGS. 1a and 1b show block diagrams of an RFID or NFC tag and a reader device according to the present disclosure.

In FIG. 1a, a passive tag 100 such as an RFID or NFC tag according to an embodiment is shown. The tag comprises a chip 110, a protective surface 130 and an antenna 140. The antenna 140 is electrically coupled to the chip 110, and the chip and the antenna are formed inside the protective surface 130. The chip may comprise analog and digital (logic) circuitry to perform its operations, and/or it may comprise one, two or more processors 120, memory 122 as one, two or more memory sections and a communication module 124 such as a radio frequency modulation circuit coupled to the antenna 140. The program and/or logic may be in the form of microcode for a processor, a gate arrangement and/or programmable logic. There may be an oscillator for determining an operating frequency for the processor.

The memory 122 may comprise executable instructions for the processor, data and information related to the operation of the tag such as en electronic product code, tag identification, check sum, passwords like an access password for accessing the tag, and user data. For example, the memory may contain a first identification identifying the tag or product to which the tag is attached. The memory may also contain a second identification identifying a person or a group of people e.g. the person who has purchased the product to which the tag is attached. The memory may also contain information for accessing a service. Some of the memory may be read-only memory, and some of the memory may be writable. The memory may be write-once memory, whereby it is programmed in an early phase in the life span of a tag, or it may be write-protected by an access password. The memory may contain an access password for verifying access rights to some functionality or to a memory area. For example, an access password may be residing in the memory, and by sending the access password to the device, access is granted to a memory area. The memory area may then contain a kill password, and sending the kill password as a parameter or argument in a “kill” command or a “destroy” command makes the tag turn inactive, i.e. kills the tag.

In the present disclosure, it has been noticed that in addition to regular memory areas, application data such as the first and second identification may be, surprisingly, stored into the kill password area, since reading the kill password area may not kill the tag.

The protective surface 130 may be made of plastic, paper or any other suitable material, preferably material that is flexible. The material may be electrically and magnetically non-conducting in order not to obstruct the operation of the antenna 140, or the material may be weakly conducting or conducting. The tag contains no battery for powering the processor. The basic operation of the tag is to extract energy from a reader signal, and to respond to the reader signal. This responding may happen by employing back-scatter modulation of the radio frequency field (e.g. for UHF tags), or by varying the load imposed by the tag on the magnetic field (e.g. for HF tags). Typically, the tag may send an electronic product code (EPC) and/or a tag identifier (TID), or an universal identifier (UID) code, EAN code, or any serial number as a response.

An RFID or NFC tag or a device may operate according to a standard. For example, the air interface may be standardized to enable interoperability of tags and reader devices. The air interface may operate according to an UHF standard wherein the tag utilizes back-scattering modulation in communication. The air interface may operate according to an HF standard wherein the tag utilizes load variation in the magnetic field. The various pieces of information stored in the tag and sent by the tag such as the EPC code may be standardized e.g. according to a Gen2 standard. The tag and/or a reader device may be standardized as a whole. The access password and/or the kill password may be determined by an EPC Gen2 standard, or they may be determined by another standard, or they may be non-standard or customized password fields.

The remote-access device, transponder or a tag may have various forms. For example, the tag may comprise an inlay placed inside plastic protective layers, or inside paper or cardboard. The remote-access device may also be a tag embedded in an object, e.g. a tag inside a food package. The remote-access device may also be any object capable of operating according to the various embodiments and being otherwise energetically essentially passive. For example, the remote-access device may be a food package, container, box, barrel, pallet, vehicle or a piece of furniture like a shelf. It also needs to be understood that a remote-access device can be without definite form or it may not be an end-product. For example, a chip for an RFID device, or the combination of a chip and an antenna may form a remote-access device in an embodiment of this present disclosure.

FIG. 1b shows an reader device 150 according to an embodiment for reading information from tags. The reader device 150 comprises digital and analog circuitry for communicating with tags e.g. RFID or NFC tags. The reader device may comprise one, two or more processors 160, memory 162 as one, two or more memory sections and a communication module 164 such as a radio frequency modulation circuit coupled to an antenna 166. The memory 162 may comprise executable program code for the processor 160, and some of the program code and other means may be for accessing a service based on a first identification and a second identification as explained earlier. The memory 162 may also comprise program code for any application, and program code for reading/writing application data or the identifications from/to the tag. The reader device 150 may be operatively connected (e.g. by means of a computer network, a fixed data connection or a wireless connection) to a computer or server 180. The computer or server 180 may comprise one or more processors 182, memory 184 and communication means 186 for communicating with computers and reader devices. The server 180 may comprise database functionality for providing a service based on information received from a tag through a reader device. The server 180 may be networked with other servers, and the server 180 may alone or together with other servers provide a network service for utilizing the information and identifiers on RFID or NFC tags.

It needs to be understood that the reader device may be a dedicated reader device like a hand-held reader or a reader integrated into another apparatus such as a vehicle or a building. It also needs to be understood that the reader device may have capability to write data into the tags, too. The reader device may also be a multipurpose device such as a personal computer, another personal electronic device such as a wrist watch or a smart phone with an RFID or NFC application and means for communicating with tags.

The RFID or NFC tag may receive a request from the reader device to send information to the reader, e.g. to send the first and/or second identification and/or to provide the information for accessing a service. This kind of ability to send the identifiers according to the embodiments of the present disclosure and/or data for accessing a service may be understood to be advanced functionalities provided by a tag.

Any methods carried out by the RFID tag and the reader device may be interlinked so that some the method steps of the RFID tag happen in response to the method steps of the RFID reader device and vice versa.

The data of the identifiers and for accessing the service may be a data table or a data structure, functionality parameters, a definition of a mathematical function or algorithm or any other data structure or object that may be used in accessing the service. For example, the data may comprise a single number, a series of numbers, a data table, a plurality of data tables, a data structure, an object definition and data, a database, and/or any combination of these alone or together with other information. The data may comprise a single packet of data, or the data to be sent may be distributed across a plurality of packets. The data (identifiers and service access information) may be complete and usable as such, or it may be such that it is augmented by other data and/or code that resides elsewhere in the system to save memory on the tag.

The reader may receive information from the tag related to availability of the first and/or second identifiers and/or information for accessing a service, as explained above. For example, the tag may have and communicate a specific code indicating that such data is available from the data.

The data may be in a protected form in either the tag memory, in the reader memory or in an external database. The protection may have been carried out so that the data resides in a memory area protected with an access key, or so that the data has been encrypted or scrambled using an algorithm dependent on an access key. This may be advantageous e.g. to protect the user identity if such has been stored on the tag as the second identifier identifying the user. The data may be wholly or partly stored in a password field of the tag, and the rest of the data may reside in normal memory on the tag, or in the reader, or in an external database. The memory may contain an address or a pointer to application data, e.g. data for obtaining access to a service or the service address directly.

The access key may be stored on the tag memory or a seed for generating the access key may be stored on the tag memory. An algorithm may be used to generate the access key from the access key seed, wherein the algorithm is such that it is unlikely that two different algorithms would produce the same exact access key. Moreover, it may be desirable that the algorithm is such that two different seeds are unlikely to produce the same access key.

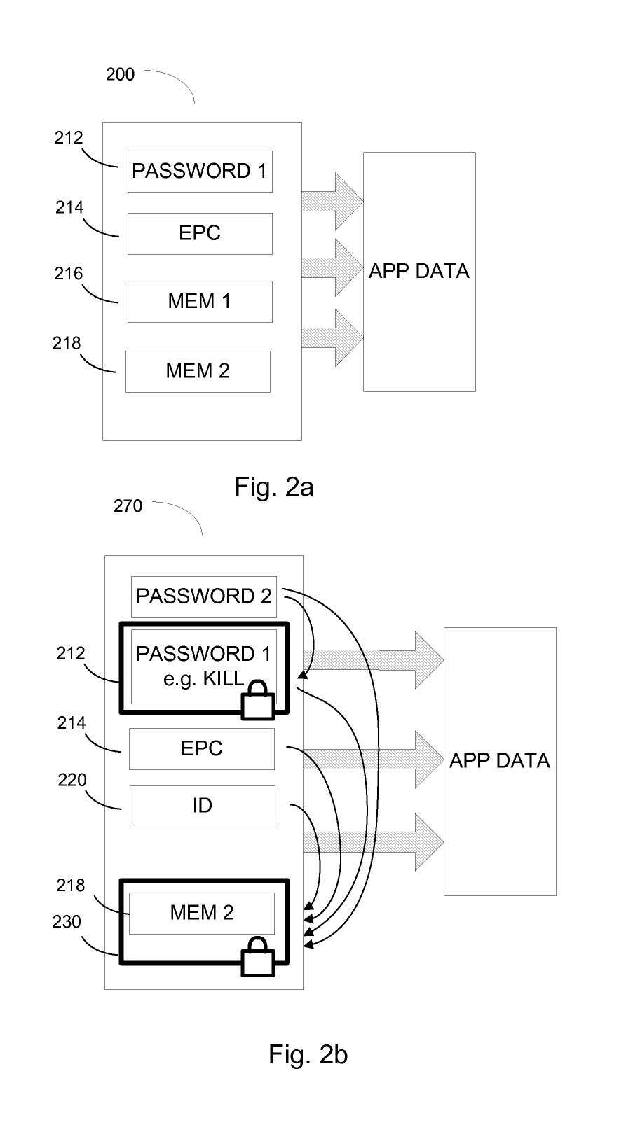

FIGS. 2a and 2b show tags with identification data stored in the tag memory according to the present disclosure. In the following, application data may comprise service information, first identification and/or second identification as explained in the context of various embodiments. Person identification may reside in a password-protected area.

In FIG. 2a, a tag 200 or any other electronic device with application data stored in a password area is shown. The tag may comprise elements as described in the context of FIG. 1a, and has a memory for holding various pieces of information. There may be a password area 212 for storing a password, and for storing application data (such as the second identifier i.e. user identification) converted into a suitable form and for storing as a password, a memory 214 for the first identifier such as an electronic product code and a memory 216 for the indicating availability of service data and a memory 218 for service access information. The various memory areas may be implemented in the same memory, or they may be implemented in different memories. Some of the memory may be read-only memory, or write-once memory, or protected from unauthorized access in some way.

In FIG. 2b, a tag 270 with application data (identifiers and/or service access information) in a password area is shown. The tag comprises elements as described in the context of FIG. 1a, and has a memory for holding various pieces of information. There may be a password area 212 for storing a password and application data in/as the password, a memory 214 for the electronic product code and a memory 218 for service access information. The password area 212 PASSWORD 1 may be protected from read and/or write access by another password PASSWORD 2, e.g. an access password. One or both of the PASSWORD 1 and PASSWORD 2 may contain data indicative of application data, or application data as such. The application data may be extracted/decoded from the PASSWORD 1 and/or PASSWORD 2 fields by a separate operation, or by a simple type conversion. The various memory areas may be implemented in the same memory, or they may be implemented in different memories. Some of the memory may be read-only memory, or write-once memory, or protected from unauthorized access in some way. The tag may also comprise a tag ID or other identification information. The data area 218 has been arranged to be such that the service access information is stored in protected form, for example in a password-protected or encrypted memory 230. The memory 230 may be protected e.g. by encryption using as a password or encryption key or a seed for a password or encryption key at least part of one or more of the data in the ID field 220, the EPC field 218, the PASSWORD 1 area 212 (e.g. KILL password) or the PASSWORD 2 area. A tag may combine any or all functionalities as explained in the context of FIGS. 2a and 2b.

The tag may contain a contiguous memory space, or the memory space may be split into a plurality of contiguous memory spaces, or the memory may comprise permanent registers for storing individual data items. For example, the memory may comprise sections for user data, for tag identification data, for electronic product code data and related data, and for other data such as passwords.

As explained above, the tag may comprise in a memory a first identifier for identifying the tag and/or the product to which the tag is attached, a second identifier for identifying a person or a group of people e.g. the purchaser of the product, and/or information for accessing a service, the service being arranged to utilize the first and second identifiers.

The first identifier may be, for example, a product code identifying a specific product. The first identifier is in a machine readable form in the tag memory, and comprises information on the product code or information such that a product code can be retrieved e.g. from a database. When a service is accessed, this product code can be used directly with the service, thereby speeding up the access and making the access more secure and reliable. The product identifier (first identifier) is conveniently available on the tag for other purposes, as well, e.g. for inventory and transportation tracking, as well as sales operations, whereby it operates as the technical means for identifying one product from another.

The second identifier may be, for example a person's name or a person identifier number or code, whereby a person can be preferably unambiguously identified, or where a group of people can be identified. For example, a person who purchases a product or a person in the transportation chain may be this person who needs to be identified. A service may be provided so that a person's identifier such as a name or a user id or a password or a code of some kind identifying the person (or the user) is provided as a credential in order to access the service. For this purpose, the service may have a list of person identifiers who are able to access the service so that authentication can be arranged. With the present disclosure, authentication can be arranged faster and in a more reliable way than e.g. by typing the name into a user id field. Alternatively or in addition to authentication, data collection related to persons acting in a system e.g. a delivery chain may be arranged so that the person identifiers are stored onto the tag and then input into the service such that information may be attributed in the service to persons and the products handled by those persons. It therefore needs to be understood that the second identifier may be such that it is not freely chosen, but instead is a person identifier from a service or a person identifier related to and stored in a system, and by storing this identifier e.g. into the tag or otherwise associating it with the first identifier, the service may be accessed with more reliable person information.

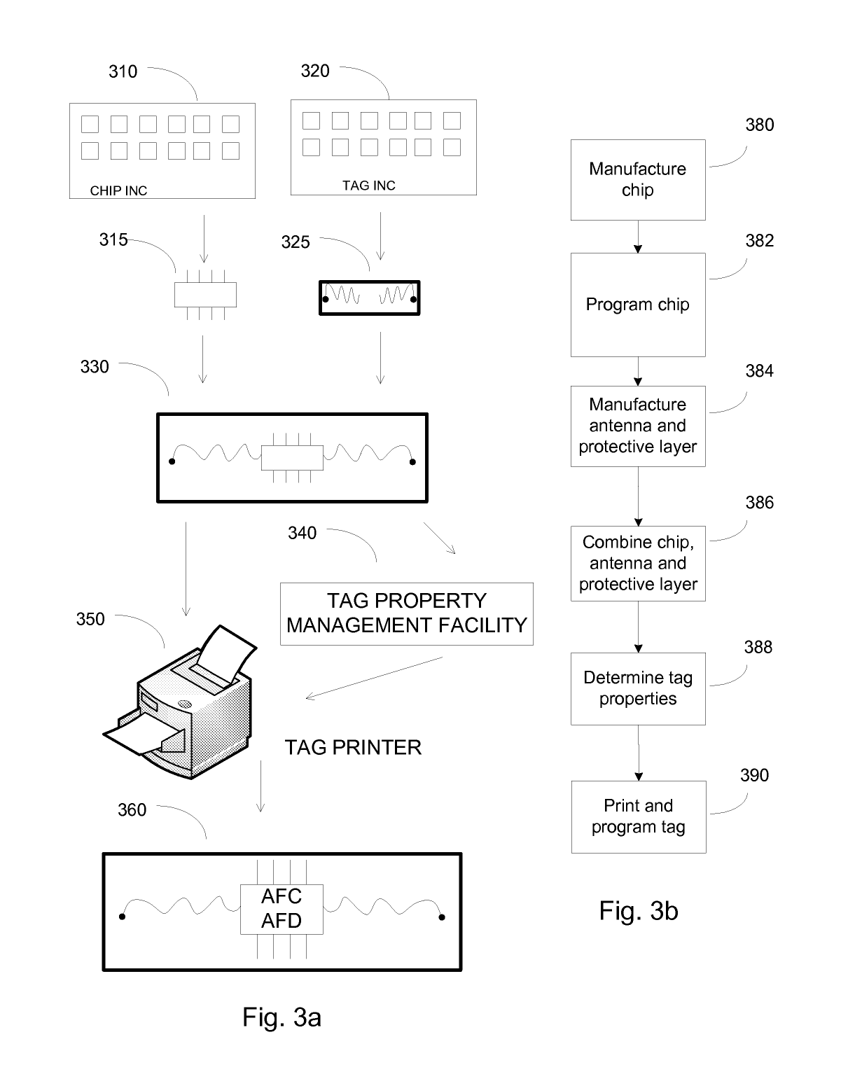

FIGS. 3a and 3b show a system and a method for manufacturing and modifying tags for accessing a service according to the present disclosure.

Manufacturing a tag may take place at a tag manufacturing facility, or it may take place elsewhere such as a factory or place of assembly where other products are being created. There may be a party who purchases empty tags and programs them to comprise service information, and/or first identification identifying a product. In other words, the party does not manufacture the tags but it may program and/or modify the tags. The party may also program the second identification to the tag, or associate the second identification in another manner to the first identifier, the second identification identifying a customer or a group of customers.

In other words, the programming of the chip may happen already by the chip manufacturer, for example already at the phase where the chips are embodied on a silicon wafer and they can be easily accessed by a programming probe. Alternatively or in addition, the chip may be programmed later as an individual chip, e.g. when it is being attached to an antenna to form a transponder. Alternatively or in addition, the chip may be programmed when the chip is part of a transponder, e.g. by programming the chip of the transponder over the air using an RFID or NFC protocol for carrying the data for programming.

The tags may be modified at any stage after manufacture. For example, modifying a tag may take place at a point of sales where a customer makes a purchase, at a wholesale point, a shipping center of a mail-order company, or by the tag manufacturer or another party selling tags e.g. based on information on a person. That is, a point of sales or another party may provide a second identification identifying a customer or a group of customers e.g. by writing it onto the tag, possibly along with the first identifier identifying a product and/or service access information providing access to a service.

FIG. 3a shows a system for manufacturing tags with data stored in the tag memory. The chips 315 for the tags may be manufactured and/or programmed by one entity 310. The antennas and the protective layers 325 may be manufactured by one or more other entities 320. The different elements making up a tag may be then combined to form a tag 330. At the time of combining or at a different time, the properties tag may be determined at 340, for example to the data to be stored into the tag memory. For example, the product identifier and the service access information may be stored into the tag memory. This may happen at any phase, e.g. during or after chip manufacturing, during or after combining the tag, or during printing (conversion), or in a completely separate phase. The tag may then be printed 350 at a facility where the tag is taken into use. The data may be stored to the memory of the tag at this point, or the storing may happen at an earlier phase. The result of this process is a tag 360 with identifier and service access data in the memory. The system in FIG. 3a may be implemented in a single facility by a single operator, or the different elements may be carried out at different locations.

FIG. 3b shows a method for manufacturing tags with application data (identifiers and service access information) stored in a memory e.g. user data memory, or password memory. The data may be in a protected memory so that it cannot be accessed without authentication, e.g. so that a key or credentials are needed to access the memory. Alternatively or in addition, the data may be in an encrypted form so that it can be deciphered using a key. Protected memory space or encryption of data may provide the advantage that e.g. person-related data (second identifier) or business-sensitive data (first and/or second identifier) can be protected against unauthorized access. For example, the first and/or second identifier may be in encrypted form, and the service to be accessed may be adapted to decrypt the identifiers or use the encrypted identifiers. Some of all of the method steps may be carried out by a single entity, or the steps may be carried out by different entities. At phase 380, the chip for the tag is manufactured so that it can provide access to a service. At phase 382, the chip is programmed, e.g. to contain program code and data for providing access to a service. For example, the tag may contain a www page written in a language like HTML, and formed so that when the user opens the web page in a browser, a number of fields is displayed for fill-in, along with a submit button. When the user presses a submit button, the web page has information coded in the HTML code so that the web browser can send an http POST request to a www address, with the field values that the user has filled in, and along with a user identifier identifying the user or a group of people.

Password areas on the chip may also be programmed, e.g. to contain application data such as calibration information. At phase 384, the antenna and the substrate layer are manufactured. At phase 386, the antenna and the substrate layer are combined with the chip to form a tag, which may be covered by additional protective layers. At this phase, password areas on the tag may also be programmed, e.g. to contain application data such as service access information. It is to be noted that for so-called passive tags, there will not be an energy source on the tag, that is, they will be energetically essentially passive. The tags will draw their energy essentially from the read-out signal, as explained earlier. At phase 388, the properties of the tag may be determined for storing onto the tag or to be kept in a database for later access based on the tag identification. For example, product identification information may be determined and password areas on the chip may be programmed, e.g. to contain application data such as service access information. At phase 390, the tag may be printed, that is, the tag may receive information such as an electronic product code. At this phase, password areas on the tag may also be programmed, e.g. to contain application data such as service access information.

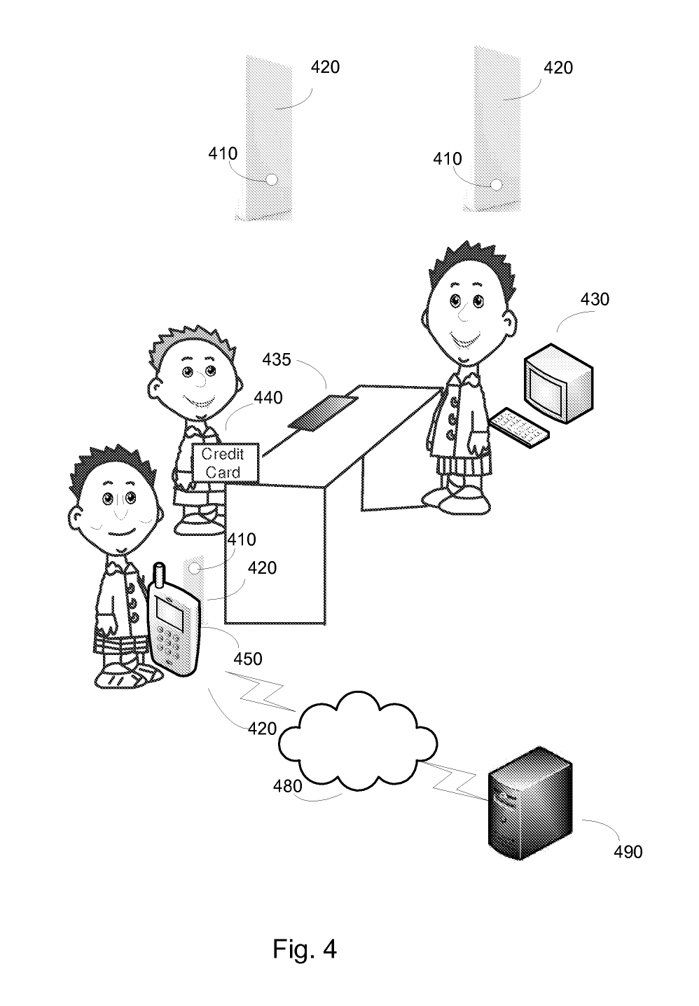

FIG. 4 shows a system for providing a service according to the present disclosure. In the figure, tags 410 may be attached to products 420 either at the point of sale or earlier. The tag may be e.g. an RFID or NFC tag, and by accessing the tag, a person may retrieve information from the tag for accessing a service 490. The service may e.g. be a feedback service where a user can provide feedback on the product, or a helpdesk service where the user can get information and help related to the product. The service may e.g. be connected or integrated into a customer relations management (CRM) system of the product manufacturer so that the manufacturer can monitor feedback for the products and form performance indicators for the management to take into account in decision making.

The tag may be provided with a second identifier identifying a person or a group of people. This may happen at a point of sales 430 of a retail store e.g. at the cashier where the customer pays for the products and provides his identification e.g. in the form of a credit card number 440 or name or loyal customer code. The identification may also be a receipt number, and the receipt number may be associated with a customer identification. In other words, when the goods are read in to the cashier system, the second identifier such as a customer identification or receipt number may be stored into the tag or into a database associated with the tag identification. Alternatively, the second identifier may be provided into the tag in a point of customer service, or at a service and repair station such as a car maintenance shop. For example, a vehicle taken into repair or maintenance may receive an NFC tag with information on the car such as manufacturer's serial number or a license plate number, information on the owner of the car, and information on a web service where further information and/or products and services related to the car or the maintenance operations performed can be obtained.

It may also be that the tags, e.g. NFC tags are provided attached on top of product packaging so that the customer may by touching the NFC tag with his phone 450 obtain access to a service 490, where information on customer satisfaction, condition and timely delivery of goods and documentation, and so on. In this manner, accessing a service using identifiers and service information from the tag may be very easy for the customer. Also, if the feedback deviates from normal, an alert may be provided to the manufacturer or seller of the product so that actions can be taken.

There are different alternative ways in which the second identifier and/or service information may be provided into the tag and associated with the product information (the first identifier). As a first example, a customer purchases goods at a web store. The seller arranges that the NFC tags are attached to the goods at the order processing center before the goods are shipped, and the tags carry the product identifications, the name of the customer or the order number, and an address through which feedback can be provided. A similar operation may take place when goods are made to order, but instead of attaching the tags to the goods at the time of order processing, they may now be attached at the time of manufacture. This makes it possible to use embedded tags where the tags are permanently embedded into the goods.

In a setting where goods are shipped, e.g. in business-to-business arrangement, the various embodiments of the present disclosure may provide additional technical features to e.g. tracking and handling goods. For example, a shipment having an RFID tag with a product id may also carry information on a person, e.g. the previous sender or the receiver. In this way, the information on the tag may be used to give feedback or tracking information on the shipment, e.g. condition of the goods, time of arrival, temperature of food items or such. In other words, the tag may hold an identifier of a product being shipped, and one or more second identifiers identifying different people in the chain, e.g. the producer of the product, the wholesale seller, the transport company or the driver of the truck on which the product is shipped, the receiver or warehouse handler etc. This information may be conveyed to a service for accessing a service e.g. so that it is read from the tag, where the product identifier and person identifier are stored (i.e. associated with each other) and then sent to a service that then provides or receives information according to the product and person identifiers. For example, the names or other identifiers of all the people who have handled the product may be stored onto the tag one by one, and sent to the service together with the product information. In this way, shipments can be easily tracked and a service can be provided where information on the shipment process and different parties involved are easily provided. The same system can be used for giving feedback on the received goods, e.g. so that the receivers identifier and the product identifier are stored on the tag.

As another alternative, there may exist a software application for a personal electronic device such as a smart phone that is capable of writing person identification into NFC tags. Such an application may be useful for marking products one's own e.g. for the purpose of theft protection, or simply for convenience of accessing a service related to the product. That is, the application, with the help of the smart phone, may store product identification, person identification and an address to web service into the tag. Later, getting service, e.g. ordering new ink cartridges to one's own printer may happen simply by touching the tag on the side of the printer and confirming the order. The tag may already contain the address where the cartridges may be ordered, specific models of the cartridges and the user information such as delivery address and phone number.

As yet another alternative, NFC or RFID tags may be provided next to a monitoring device such as an electrical power consumption meter. By touching the tag with a reader, the user may easily access a service where he can monitor power consumption or report the readings himself. As a general pattern, it may be possible to use the tags so that they provide access to a service and accessing the service without information contained in the tag may not be possible. Yet further, the tags may be placed in a location where there is no public access, making it difficult to access the service without authorization.

The provision of the service may happen based on the identifiers and service access information in the tag. The determination of the service to be provided may happen directly based on this data, or it may happen in a partially or completely random manner. For example, feedback questions may be picked from a number of questions. The user identification may be stored into the service so that the person accessing the service may be identified for the purpose of monitoring feedback. Having the person identity available may make it possible to customize the service based on the person, e.g. by suggesting a point of service near the person's home address. The service may use an application in a smart phone, or it may use a regular web service, or a combination of these.

In any embodiment, it needs to be appreciated that there may be one or more first identifiers identifying a tag or a tagged object, as well as one or more second identifiers identifying a person or a group of people. For example, several people identifiers may be stored into the tag as the tagged object passes through a transport chain or a sales chain.

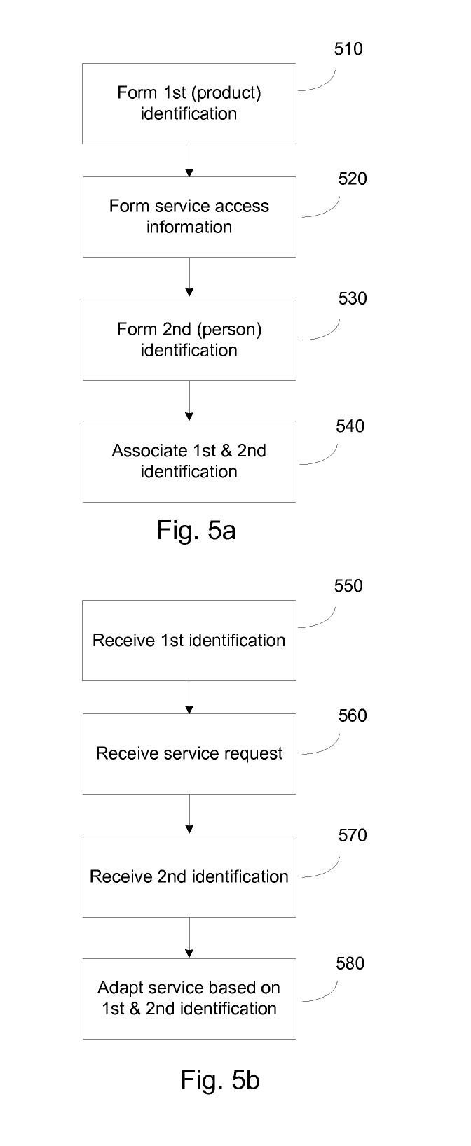

FIGS. 5a and 5b show a flow chart for accessing a service and for providing a service according to the present disclosure. The present disclosure may be applied to provide a product-related service to a customer in an easy way, and at the same time provide feedback on the customer satisfaction to the seller and/or manufacturer of the product. The present disclosure may thus provide for more real-time information on customer satisfaction than earlier solutions. The present disclosure may e.g. be utilized with smart phones and other personal electronic devices employing the NFC technology.

In FIG. 5a, a first identification is formed in a tag in phase 510. The first identification may be a tag identifier, a product code such as an EAN code (International article number), or simply a product name, type or other identifier for identifying the product. If a tag identifier is provided, the association to a product may exist e.g. in a database so that a tag identifier is mapped to a product identifier. The first identifier may be formed when the tag is attached to the product at time of manufacture, or when the tag is attached to the product at a later time such as in a wholesale point or at a retail point. In other words, the tag may be programmed at any point to contain a product identifier such as a product code or a serial number, or the tag may even be pre-programmed so that a batch of tags carries product identifiers already before they are attached to products. Pre-programming may make it easier to use the tags e.g. at a point where reader/writer devices are not available. Pre-programming the tags may also make it faster to apply the tags on products. The tags may carry a visual indication of the first identifier, e.g. they may have a product identification printed on the tag so that it can be read by a human, or they may carry a bar code so that the tag may be read by a simple bar-code reader. In this manner, it may be feasible to attach specific tags to specific products. In any event, at some point of time, the tag that is attached to a product carries a first identifier that can be used to identify the product to which the tag is attached, either as an individual product, product type, product group, product batch or such.

In phase 520, information may be formed to access a service. For example, a uniform resource identifier (URL) such as a network address like an internet page identified with an hypertext transfer protocol (http) address may be formed. The information may comprise a message such as a short message (SMS) or an e-mail together with an address or number to which the message is to be sent. The information may comprise a program or program module identifier so that a program may be identified to be run so that a service may be provided. The service may use the first identifier to provide a specific service depending on the first identifier, e.g. by choosing or forming a web page based on a product identifier.

In phase 530, a second identification for identifying a person or a group of people may be formed. The second identification may be formed as soon as there is an association with the specific product and the person, e.g. when the person has purchased or rented the product. The second identification may be any information that can directly or indirectly be used for identifying a person or a group of people such as a sale receipt number, a customer name (that is, a person's name or a company name), a customer payment card or identification card number or code, a loyal customer identifier, a zip code, a telephone number or area code, a sales clerk identifier, a store identifier, a location identifier or a time. Some second identifiers like the customer name may be used directly to identify an individual person, while some others like a company name may be used to identify a group of people. Some second identifiers may allow indirect identification of a person or a group of people such as a sale receipt number (with look-up from a database), time of sale (all people who made a purchase at that time) or a salesperson identifier (customers of that specific salesperson).

In phase 540, the first identification and the second identification are associated with each other. For example, if a customer has given his loyal customer card to the salesperson at the point of sale, the cashier system may write the second identifier into the NFC tags of the products that the customer has purchased. In this way, the products may e.g. comprise the customer's name, user id to a service, a loyal customer number or such. Alternatively, the customer identification (second identifier) may be associated to the purchased product(s) in a database e.g. in the service system. This may make it feasible to associate the first and second identifiers to each other also when the customer only gives his personal information at the end of the purchase event e.g. by paying by credit card. In any event, the first and second identifiers may be associated so that they are both stored in the tag memory so that a service can be accessed using both identifiers, or they may be associated externally from the tag e.g. by means of a database mapping the first and second identifiers to each other. The first and second identification may be associated with the service information. For example, a single URL may be formed containing all the three pieces of information and stored into the tag memory. An example URL address like this may be of the form http://service.com/page?prod=gadget1234&cust=johndoethesecond.

In FIG. 5b, the first identification is received at a service provider in phase 550. The first identification may be received after reading it from a tag e.g. with the help of a smart phone reader application and after sending it from the smart phone to the service provider. In phase 560, a service request may also be received, being a generic service request or identifying a specific service among a plurality of services. The service may use the first identifier to tailor or to build the service.

The user device such as a smart phone or a dedicated reader may have functionality so that the identity of the user can be verified e.g. before sending the request. The user information of the user device like the smart phone may be compared to the second identifier from the tag, and if a match is determined, the service may be accessed, otherwise access is not allowed. Alternatively, the tag may comprise functionality for verifying user information from the user device. For example, the tag may comprise service access information and/or the second identifier in a password-protected memory, wherein the password may be a user identification from the user device, or related to the same. Yet further, the tag may be programmed so that the tag provides the service access information only if the user identification from the user device and the user identification on the tag are determined to match. In this manner, only authorized users may be allowed access to the service. For example, only users who actually purchased the product may be able to provide feedback on the product or get a service related to the purchase.

In phase 570, the second identification may be received, and the service may be adapted further by using the second identifier in phase 580. For example, the service may look up any earlier services provided to the same user based on a received user identification, or the service may provide recommendations based on the group of people the user belongs to. If the service is a network service where goods can be purchased, the service may adapt recommendations of relevant products and/or product prices based on the first and second identifiers. As another example, a customer may use his smart phone to read the service information (web address), a product code and his loyal customer number from an NFC tag by touching the tag. The customer may then use a web browser in the phone to access a feedback page in the internet, as described earlier, and after giving the feedback, the customer may receive a ringing tone, game, song, balance on a service account or any other reward.

It needs to be understood that the product may be a physical product such as a food package, an appliance for personal use, a vehicle, or a part for such, or the product may be a ticket or receipt allowing access to an event, place, service or such.

The various embodiments of the present disclosure can be implemented with the help of computer program code that resides in a memory and causes the relevant apparatuses to carry out the present disclosure. For example, a tag, a chip or a reader device may comprise circuitry and electronics for handling, receiving and transmitting data, computer program code in a memory, and a processor that, when running the computer program code, causes the reader device to carry out the features of an embodiment. Alternatively or in addition, a tag or a chip for a tag or a reader device may comprise logic circuitry for implementing the same functionality as may be carried out by means of program code run on a processor. Yet further, a network device may comprise circuitry and electronics for handling, receiving and transmitting data, computer program code in a memory, and a processor that, when running the computer program code, causes the network device to carry out the features of an embodiment. A system may comprise any number of tags of the same kind or different kinds, and reader devices and network computers in any combination.

It is obvious that the present disclosure is not limited solely to the above-presented embodiments, but it can be modified within the scope of the appended claims.

1. A method for providing access to a service, comprising:
forming a first identification for identifying a tag or a tagged object, and
forming information for accessing a service, said service being adapted to utilize said first identification or first data derived from said first identification,
forming a second identification for identifying a person or a group of people, wherein said service is adapted to utilize said second identification or second data derived from said second identification,
associating said second identification with said first identification for providing access to said service by storing said second identification into said tag and storing said information for accessing said service into said tag.

2. A method according to claim 1, wherein said second identification is formed at a point of sale by using customer information in response to said customer making a purchase of a product to which said tag is attached.

3. (canceled)

4. A method according to claim 1, wherein said method comprises:
storing said second identification on a computer in a network, and
associating said first identification with said second identification on said computer.

5. (canceled)

6. A method according to claim 1, wherein said first identification comprises at least one from the group of a tag identifier, a product identifier, an article number, a serial number, a type identifier, a name of a product, a name of a company having manufactured the product, a link to a product-specific service and a link to a product-type-specific service.

7. A method according to claim 1, wherein said second identification comprises a sale identifier such as a sale receipt number, a customer name, a customer payment card number, a loyal customer identifier, a sales clerk identifier, a store identifier, a location identifier or a time.

8. A method for providing a service, comprising:
receiving a first identification for identifying a tag or a tagged object, wherein said first identification is received from a tag memory, and
receiving a service request comprising information for accessing a service such as an address to said service, said service being adapted to utilize said first identification or first data derived from said first identification,
receiving a second identification for identifying a person or a group of people, wherein said service being adapted to utilize said second identification or second data derived from said second identification, said second identification being associated with said first identification, and
providing a service based on said first identification and said second identification.

9. A method according to claim 8, wherein said second identification is received from a tag memory.

10. A method according to claim 8, wherein said method comprises:
receiving said second identification from a network server based on said first identification.

11. A method for providing a service according to claim 10, further comprising:
using said first identification or said second identification as a basis for randomly generating service.

12. A method according to claim 11, wherein said first identification comprises at least one from the group of a tag identifier, a product identifier, an article number, a serial number, a type identifier, a name of a product, a name of a company having manufactured the product, a link to a product-specific service and a link to a product-type-specific service.

13. A method according to claim 12, wherein said second identification comprises a sale identifier such as a sale receipt number, a customer name, a customer payment card number, a loyal customer identifier, a sales clerk identifier, a store identifier, a location identifier or a time.

14. A method for accessing a service, comprising:
forming a first identification for identifying a radio frequency identification tag or a tagged object,
forming information, such as a hyperlink, for accessing a service based on said first identification or first data derived from said first identification,
forming a second identification for identifying a person or a group of people, wherein
said service is adapted to utilize said second identification or second data derived from said second identification,
associating said second identification with said first identification by
retrieving said first and second identification for accessing said service from a tag memory, and
accessing said service by using said first and second identification.

15. A transponder tag, comprising a first identification for identifying said tag and for accessing a service, and a second identification for identifying a person or a group of people and for accessing a service, said service being adapted to utilize said first identification or first data derived from said first identification and said second identification or second data derived from said second identification.

16. A tag according to claim 15, comprising information for accessing said service in said tag, said information comprising an http address or a server IP address.

17. A tag according to claim 16, wherein said second identification comprises a sale identifier such as a sale receipt number, a customer name, a customer payment card number, a loyal customer identifier, a sales clerk identifier, a store identifier, a location identifier or a time.

18. A system for providing access to a service, said system comprising memory and at least one processor, the system further comprising computer program code in said memory, said computer program code arranged to, when executed on said at least one processor, cause the system to:
form a first identification for identifying a tag or a tagged object, and
form information for accessing a service, said service being adapted to utilize said first identification or first data derived from said first identification,
form a second identification for identifying a person or a group of people, wherein said service is adapted to utilize said second identification or second data derived from said second identification,
associate said second identification with said first identification for accessing said service by storing said second identification in said tag.

19. A system according to claim 18, the system further comprising computer program code arranged to cause the system to:
determine customer information in response to said customer making a purchase of a product to which said tag is attached; and
form said second identification by using said customer information.

20. (canceled)

21. A system according to claim 19, the system further comprising computer program code arranged to cause the system to:
store said second identification on a computer in a network, and
cause said first identification to be associated to said second identification on said computer.

22. (canceled)

23. (canceled)

24. (canceled)

25. A computer program product comprising computer program code embodied on a non-transitory computer-readable medium, the computer program code being configured to, when run on at least one processor, cause a computer system to:
receive a first identification for identifying a tag or a tagged object, wherein said first identification is received from a tag memory, and
receive a service request comprising information for accessing a service such as an address to said service, said service being adapted to utilize said first identification or first data derived from said first identification,
receive a second identification for identifying a person or group of people, wherein said service being adapted to utilize said second identification or second data derived from said second identification, said second identification being associated with said first identification, and
provide a service based on said first identification and said second identification.
